(19) United States
(12) Patent Application Publication
(10) Pub. No.: US 2023/0375121 A1
(43) Pub. Date: Nov. 23, 2023

(54) CONDUIT COUPLING

(71) Applicant: S-P Products, Inc., Elk Grove Village, IL (US)

(72) Inventor: Mikel Bishka, Glendale Heights, IL (US)

(21) Appl. No.: 18/198,632

(22) Filed: May 17, 2023

Related U.S. Application Data
(60) Provisional application No. 63/343,648, filed on May 19, 2022.

(51) Int. Cl. F16L 41/10; F16L 41/08

(52) U.S. Cl. CPC F16L 41/10; F16L 41/082

(57) ABSTRACT

A conduit coupling assembly facilitates connection of tubing with a conduit section through which associated electrical wiring and/or cables are routed. The assembly includes a conduit coupling, which is joined the conduit section which projects above an associated concrete slab or the like. The conduit coupling assembly thus particularly facilitates routing of wiring from a conduit section positioned within a concrete slab or like flooring element, through the conduit coupling, and associated conduit or tubing.

### CROSS-REFERENCE TO RELATED APPLICATIONS

This application claims priority of Provisional Ser. No. 63/343,648, filed May 19, 2022, the disclosure of which is hereby incorporated by reference in its entirety.

### FIELD OF THE INVENTION

The present invention relates generally to assembly of conduits, tubing, and like components in a building or other structure, and more particularly to a conduit coupling which facilitates joining liquid-tight connectors to a conduit positioned in a concrete slab or similar environment. The present coupling assembly facilitates attachment of threaded polyvinyl chloride (PVC) conduit material to an associated, PVC component mounted in a concrete slab or the like.

### BACKGROUND OF THE INVENTION

Electrical conduit and related accessories may be made from a variety of materials such as PVC, thin wall metal, heavy wall metal, flexible tubing (MC cable and other types of flexible cable), as well as other materials known to those skilled in the art. For some applications, composite conduit assemblies, such as comprising a metallic core and a polymeric protective coating, are required. Often-times, these materials are used in combination and therefore, adapters and couplings must be used to join the materials. Couplings are generally used to connect tubing, such as electrical conduit to various other forms of electrical tubing and support structures. In some applications, electrical conduit can be arranged to extend at least partially within a floor structure, such as a concrete slab.

In the course of a typical installation, it may be necessary for electrical workers to provide conduit components which extend from within a concrete slab or like floor element for connection with other components positioned about the concrete slab. Bearing in mind that electrical wiring positioned within the conduit components must be threaded and directed through the various components, it is desirable to provide an arrangement which facilitates assembly of the components, while promoting efficient routing of the associated wiring.

The present invention is directed to conduit coupling which facilitates assembly of liquid-tight connectors, and associated tubular structures, with conduit components typically used in conjunction with electrical wiring, with the present invention particularly suited for applications in which conduit components are positioned in a concrete slab or like flooring structure.

### SUMMARY OF THE INVENTION

The present invention is directed to a conduit coupling and method of installation which particularly facilitates efficient connection of liquid-tight connectors and associated tubing to conduit components, typically polyvinyl chloride (PVC), positioned in a concrete slab or like structure. The assembly can be used in wet environments, such as in the area of cooling towers in data centers. Connection from concrete pads to various heating, ventilation and air conditioning equipment is facilitated. Time savings can be achieved for transitioning from PVC conduit to PVC conduit above the slab without damaging PVC risers and chipping concrete, eliminating concrete repair work.

In accordance with the present invention, the present method of forming a coupling assembly comprises the steps of providing a conduit, typically formed from polyvinyl chloride (PVC) in an associated building slab, or like structure, so that the conduit projects from the surface of the slab. The method includes cutting a portion of the conduit which projects above the surface of the slab to prepare the conduit for connection.

The present method further contemplates cutting the conduit at an inside surface thereof to form a connection region, which is preferably tapered. This step is preferably effected by reaming the interior surface of the conduit to provide an inner surface for assembling the components of the assembly.

Next, a conduit coupling is provided, with the coupling inserted into the conduit in the tapered, connection region of the conduit. Industrial grade adhesive is provided to securely and permanently adhere the transition coupling to the conduit.

The assembly is completed by joining the coupling to an associated PVC conduit positioned exteriorly of the slab. To this end, coupling is preferably provided with a female thread formation on an interior surface therefore for threaded engagement with a male thread formation provided at an interior surface of the conduit joined to the coupling. Adhesive applied to the thread formations secures them to each other.

Other features and advantages will become readily apparent from the following detailed description, the accompanying drawings, and the appended claims.

### BRIEF DESCRIPTION OF THE DRAWINGS

FIG. 1 is a perspective view of a conduit coupling for practice of the present invention; and

FIGS. 2-5 are diagrammatic views illustrating the sequence of steps for forming a coupling assembly in accordance with the present invention.

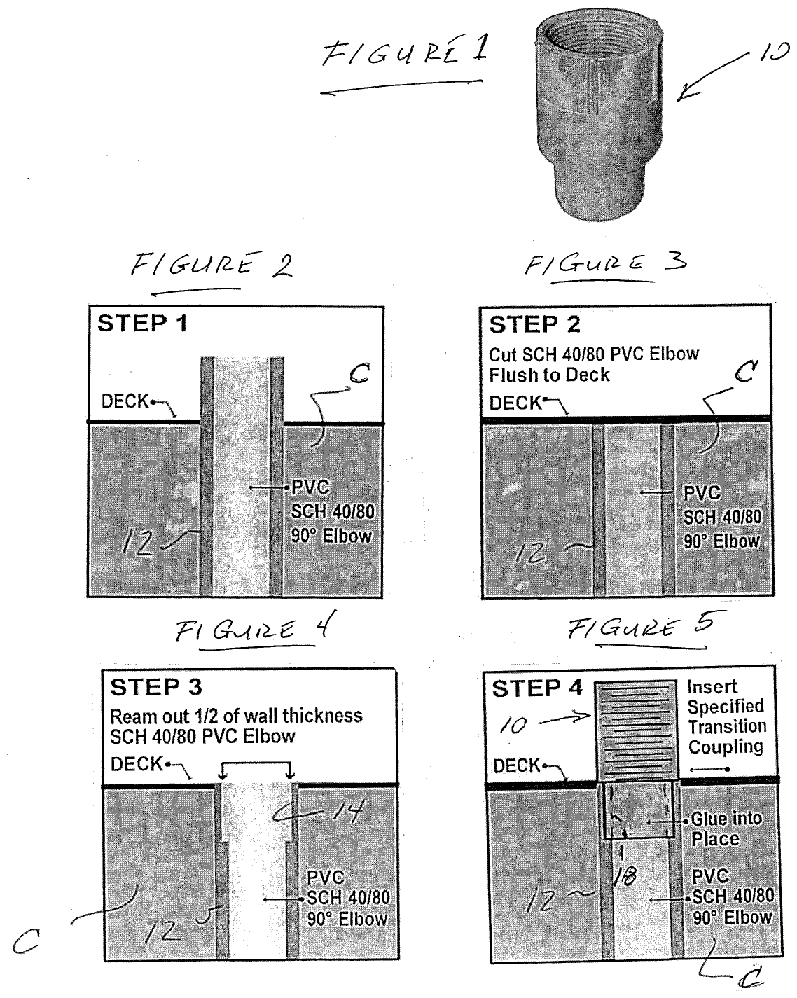

### DETAILED DESCRIPTION

While the present invention is susceptible of embodiment in various forms, there is shown in the drawings and will hereinafter be described a presently preferred embodiment, with the understanding that the present disclosure is intended as exemplification of the invention, and is not intended to limit the invention to the specific embodiment.

This invention pertains to couplings and adapters for conduits and tubular members, and in more particularly to an arrangement including a conduit coupling configured to facilitate connection of liquid-tight tubing or conduit to an associated conduit section, wherein the conduit section is disposed in an associated floor or concrete slab. Associated electrical wiring or the like can be arranged to extend from within the conduit in the concrete slab, and through the coupling assembly and the associated liquid-tight tubing.

With reference to the illustrated embodiment, the present invention is directed to a conduit coupling, designated 10, and a method of installation which particularly facilitates efficient connection of associated tubing to conduit components, typically polyvinyl chloride (PVC), positioned in a concrete slab C or like structure. The coupling 10 can be used in wet environments, such as in the area of cooling towers in date centers. Connection from concrete pads to various heating, ventilation and air conditioning equipment is facilitated.

In accordance with the present invention, the present method of forming a coupling assembly comprises the steps of providing a conduit 12, typically formed from polyvinyl chloride (PVC) in the associated building slab C or like structure so that the conduit projects 12 from the surface of the slab, as shown in Step 1.

As shown in Step 2, the present method includes cutting a portion of the conduit 12 which projects above the surface of the slab C to prepare the conduit for connection.

As shown in Step 3, the present method next contemplates cutting the conduit 12 at an inside surface thereof to form a connection region 14, which is preferably tapered inwardly in a direction away from the conduit opening, i.e., downwardly and inwardly in the illustrated embodiment. This step is preferably effected by reaming the interior surface of the conduit 12 to provide an inner surface at 14 for assembling the components of the present assembly.

Next, the conduit coupling 10, configured in accordance with the present invention, is provided, with the coupling 10 inserted into the conduit 12 in the tapered, connection region 14 of the conduit. The coupling 10 is preferably formed for PVC for economical and durable service. The exterior of the coupling is provided with a tapered surface which is complementary to the tapered, connection region 14 of the conduit 12. Industrial grade adhesive is provided to securely and permanently adhere the transition coupling to the conduit. Step 4 shows this step of the process, with the conduit coupling 10 illustrated joined to the conduit 12. As illustrated, the inside diameter of the coupling 10, as shown in phantom line at 18, can be the same as the inside diameter of conduit 12 to facilitate the smooth passage of wiring through the assembled components.

The present coupling assembly is completed by joining the coupling 10 to associated conduit or tubing positioned exteriorly of the slab C. To this end, the coupling 10 is preferably provided with a female thread formation on an interior surface thereof for threaded engagement with an external, male thread formation provided on the associated conduit or tubing. Adhesive applied to the thread formations secures them to each other.

As will be appreciated from the above description, the exact order in which components of the present assembly are joined to each other and assembled can be varied in accordance with the requirements of any specific application.

From the foregoing, it will be observed that numerous modifications and variations of the present invention can be effected without departing from the true spirit and scope of the novel concept of the present invention. It is to be understood that no limitation with respect to the specific embodiment illustrated herein is intended or should be inferred. The disclosure is intended to cover by the appended claims all such modifications as fall within the scope of the claims.

What is claimed is:

1. A method of forming a coupling assembly, comprising the steps of:
providing a conduit in an associated building slab so that said conduit projects from the surface of the slab;
cutting a portion of said conduit which projects above the surface of the slab;
cutting said conduit at an inside surface thereof to form a connection region;
providing a conduit coupling;
inserting said conduit coupling into said connection region of said conduit, and securing said transition coupling to said conduit; and
joining associated conduit or tubing to said coupling, to thereby facilitate joining said associated conduit or tubing to said conduit in the associated slab.

2. A method of forming a coupling assembly in accordance with claim 1, including cutting said conduit at the inside surface thereof by reaming said conduit.

3. A method of forming a coupling assembly in accordance with claim 1, including cutting said conduit at the inside surface thereof at a taper.

4. A method of forming a coupling assembly in accordance with claim 3, including providing a female thread formation on an interior surface of said conduit coupling, and providing a male thread formation on an exterior surface of the associated conduit or tubing and engaging said male and female thread formations. for joining said male connector to said transition coupling.

5. A method of forming a coupling assembly in accordance with claim 4, including providing an adhesive for adhering said male and female thread formations to each other.

6. A method of forming a coupling assembly in accordance with claim 1, wherein said conduit coupling comprises polyvinyl chloride.
